(19) United States
(12) Patent Application Publication
(10) Pub. No.: US 2017/0266752 A1
(43) Pub. Date: Sep. 21, 2017

(54) WELDING HEAD FOR MAGNETIC PULSE WELDING OF TUBULAR PROFILES TO A CYLINDRICAL INNER MEMBER

(71) Applicant: Valmet AB, Sundsvall (SE)

(72) Inventors: Martin Apel, Mölndal (SE); Krister Pettersson, Stenungsund (SE)

(73) Assignee: Valmet AB, Sundsvall (SE)

(21) Appl. No.: 15/504,789

(22) PCT Filed: Aug. 18, 2014
(86) PCT No.: PCT/SE2014/050947

§ 371 Date: Feb. 17, 2017

(51) Int. Cl. B23K 20/06; H05B 6/36

(52) U.S. Cl. CPC B23K 20/06; H05B 6/36; B23K 2201/14

(57) ABSTRACT

The invention relates to a welding head for magnetic pulse welding of hollow thin-walled profile to an inner member having a complementary outer form to said hollow thin-walled profile. The weld head comprises two movable weld head halves (10a,10b) forming said weld head wherein each half has at least one individual induction coil (12a,12b) connected to a power source independently from the other weld head half, with coils wound in a kidney-shape. The work piece is clamped between shapers (15a,15b) integrated with each half. With this weld head could for example work pieces such as tubular thin-walled profiles be welded, even if they are integrated in a closed tubular design, as the weld head could be closed quickly over the welding position and opened for release of the work piece without experiencing arching in clamping area.

### FIELD OF THE INVENTION

The present invention relates to a magnetic pulse welding device, and more particularly to a magnetic pulse welding head having a split coil design, thereby allowing opening and closing of the welding head around the welding point.

### BACKGROUND OF THE INVENTION

The magnetic pulse welding (MPW) or forming process utilizes electromagnetic energy to create a metallurgical bound at molecular level without melting the materials to be joined. It was first developed in the 1970s and was disclosed in;
Epechurin, V. P. ; “Properties of bimetal joints produced by magnetic-pulse welding”, Welding Productions, Vol. 21, No, 5 pp. 21-24 (1974), and
Brown, W. F. & Bandas J & Olson N. T; “Pulsed magnetic welding of breeder reactor fuel pin and closures”, Welding Journal, No. 6, pp 22-26 (1978).

The MPW process is based on well-established electromagnetic theory and is suitable for joining thin-walled tubular structures with either solid mandrels, or with other tubular elements. The concept is based upon deformation of an electrically conductive tubular element having a certain amount of plastic deformation capability. The other element to be joined with the tubular element can be of another material, even a non electrically conductive material. If two tubular parts are to be joined, then one tube is inserted into the other tubular element, preferably with as less play as possible between contact surfaces, forming a lap type of joint, and then applying an electromagnetic pulse over this lap joint.

The passage of a high current discharge from the MPW power source trough a specially designed coil and field shaper assembly creates an induction current (eddy current) in the conductive outer tubular element. Interactions of the electromagnetic fields associated with the primary discharge current and the eddy current results in a repulsion force (the “Lorenz” force) between the coil and the outer tubular element. The magnitude of the repulsion force is approximately proportional to the square of the discharge current.

The MPW process is designed to create a repulsion force powerful enough to cause the outer tubular element impacting the inner tubular member at a velocity that is sufficiently high, in the range of several hundred meters per second (Kojima, M; Tamaki, K; Suzuki, J; and Sasaki K; “Flow stress, collision velocity and collision acceleration in electromagnetic welding. ” Quarterly Journal of the Japan Welding Society, 7(1), pp 75-81, 1989), for localized deformation and subsequent bonding.

Fundamentally, the MPW process follows the same physics principles as the electromagnetic forming process see;
Plum, M; “Electromagnetic Forming”, Metals Handbook, volume 14, 9^{th} edition, ASM, 645; 1995; and
Daehn, G. S; Vohnut, V. J.; & Datta, S, “Hyperelastic forming: process potential and factors affecting formability”; Materials Research Society, Superplasticity-Current Status and Future Potential (US), pp. 247-252, 2000; and
Daehn, G. S; “High Velocity Sheet Metal Forming: State of the Art and Prognosis for Advanced Commercialization”.

However, the MPW process may require a much higher repulsion force to generate sufficient velocity for bonding.

The MPW process is particularly useful in making strong metallurgical bond between dissimilar materials such as aluminum to steel, a task that is generally impossible with traditional welding processes. The MPW technology will have broad commercial applications in a number of industries including automotive, aerospace, appliance, electronic and telecommunications. Especially in the automotive and aerospace technology will MPW provide means for manufacturing light-weight chassis using tubular frames.

The MPW technology will potentially revolutionize the assembly process of hydro formed tubular structures in next generation energy efficient automotive vehicles. It can become a critical technology, enabling materials joining technology to promote hybrid automotive body structure design that uses aluminum alloys and steels. In addition, MPW welding is ideal to replace certain brazing and soldering operations of tubes and electrical connectors, thus eliminating a number of environmental concerns associated with brazing such as energy consumption, use of hazardous chemicals, and costly recycling of lead containing brazed parts.

Since the invention of the MPW process, the conventional design of the induction coil has been a closed electrical loop encircling the point of welding, i.e. encircling the tubular element to be welded. Similar to a solenoid in principle, the closed coil design provides a closed loop for passage of the discharge current around the tubular part to be welded. The looped path was considered to be necessary for the generation of the repulsion force for sufficient bonding. The welded assembly could only be removed axially from the closed coil of the welding head, which meant that welding of closed tubular structures was impossible, i.e. structures similar to toroids and similar closed tubular structures.

Different proposals for welding heads of this conventional closed coil design are shown in;
U.S. Pat. No. 5,824,998; showing a welding head for electrical connectors, with coil totally encircling the weld position,
U.S. Pat. No. 5,981,921; showing a welding head with coils totally enclosing the weld position, thus must be able to be withdrawn axially from the welded tubular member (no closed tubular structure possible),
U.S. Pat. No. 5,966,813; showing similar type of welding head as in U.S. Pat. No. 5,981,921,
U.S. Pat. No. 6,255,631; showing a welding head for expanding an inner tube against a surrounding hole structure.

The closed coil design has imposed significant restrictions in application areas for the MPW technology. The restrictions apply for closed tubular structures where the welding head could not be removed after the welding process. In some applications the shape of hydro formed tubes are quite complex, preventing a physical removal of the welding head after welding. Therefore the coil of the welding head needs to be redesigned so that weld heads could be quickly opened and closed allowing the loading and unloading of the hydro formed tubes.

Some attempts have been made to design a weld head that could be opened and closed much like clamshell halves, utilizing conducting surfaces between halves closing the electric discharge path of the coils.

However, if the electric current for exciting the coils is passed via such conducting surfaces they will be exposed to excessive wear and will be destroyed during operation due to arcing of electrical current. The electrical current developed for MPW needs to approach 1 mega ampere of current during the 100 microseconds that it takes to make the weld, all without excessive heating. The contact surfaces have to be “perfect”, i.e. with no air gaps or oxidation which may cause arcing during operation. The welding head needs to withstand some 100.000 welds for economic feasibility of the process.

An example with clamshell like opening of coils over welding position is shown in U.S. Pat. No. 6,229,125. This solution show two separate coils positioned in tandem along the axis of the coils, but where only one coil is connected to a power source, while the second coil is simply only a stand-alone coil which reflects a countercurrent pulse. However, this design also does not utilize a magnetic field in the volume encircled by the coil inner surface, where the magnetic field is most intensified.

Another solution with dual coils is shown in U.S. Pat. No. 6,875,964, where two coils mounted in each weld head half are connected in series, using a connecting pin for connecting coils together. The problem with arcing in the connecting surfaces of this connecting pin will still create problems, and coils could not be controlled individually. Here are the two halves also totally encircling the welding position which makes it impossible to use in designs having neighboring tubular elements close to the welding position.

What is needed is a MPW head that could be opened and closed quickly allowing loading and unloading of work pieces without having to pull out the weld head over the entire length of the work piece. Further, the problem with arcing should be avoided in contact surfaces extending service life of the weld head and thus the economical feasibility of the process. Yet another problem is to be able to weld tubular elements in designs having several tubular elements located close to one another.

### BRIEF DESCRIPTION OF THE INVENTION

It is an object of the present invention to prevent the problems in existing solutions.

According to the invention are two independent coils with their own power supply used in two weld head halves that easily could be opened and closed over the welding position.

Another advantage of the invention is that no electrical connectors for conducting high-ampere currents are needed to be connected for exiting the coils, which will dramatically improve service operation of the weld head.

Yet another advantage is the use of kidney-shaped coil housing that both concentrated the magnetic pulse towards the welding position as well as better access to the weld position if it is problematic to apply the weld head all around, i.e. totally encircling, the welding position.

### BRIEF DESCRIPTION OF THE FIGURES

In the following a preferred embodiment of the invention will be described with reference to the attached drawing, in which

FIG. 1 show a welding head in a perspective view according the invention, having two weld head halves 10a and 10b;

FIG. 2 show a principle flat view of the weld head according to the invention;

FIG. 3 showing the weld head with a work piece clamped between weld head halves;

FIGS. 4a-4c showing different workpieces clamped between weld head halves;

FIG. 5 showing a sectional view seen in II-II in FIG. 2 of upper weld head half.

### DETAILED DESCRIPTION OF THE PREFERRED EMBODIMENT

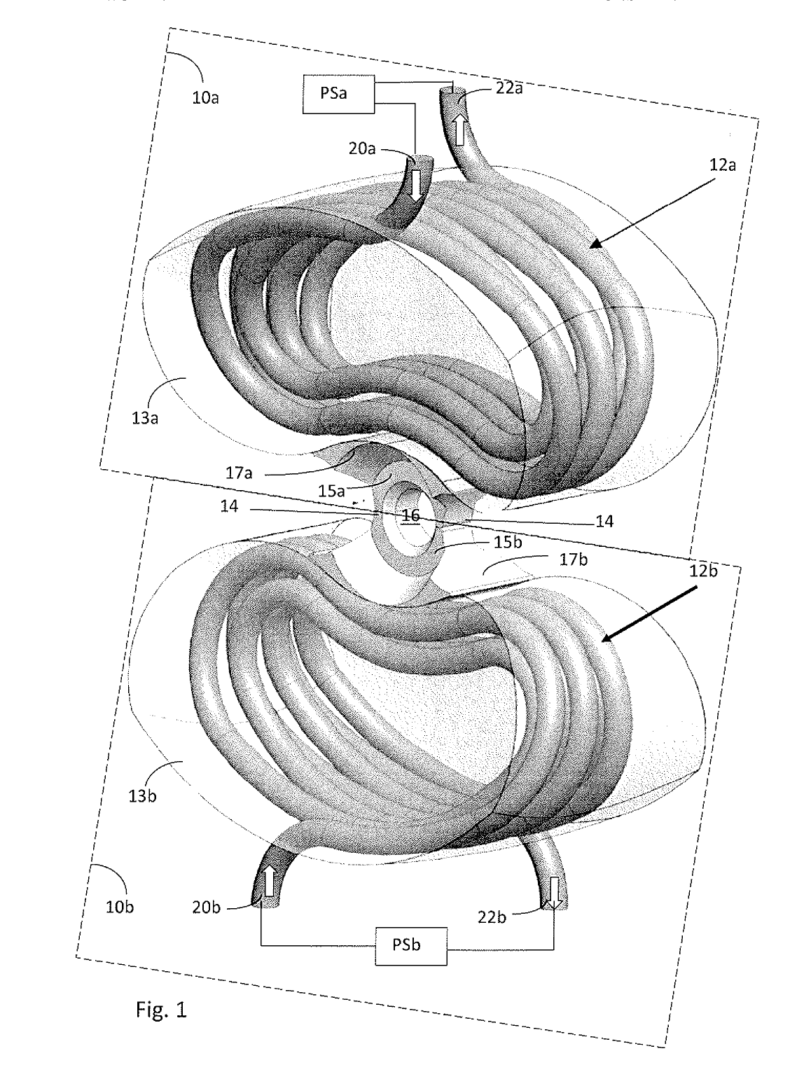

As seen in FIG. 1 is the weld head for magnetic pulse welding made as two independent weld head halves 10a and 10b, each half including at least one uninterrupted coil winding 12a and 12b respectively. The halves are brought together via abutting contacting surfaces 14, which encircles a work piece receiving zone 16. Each coil winding 12a and 12b is connected to an independent power source PSa and PSb, such that each coil winding could be controlled independently of the other coil winding.

Similar parts in upper and lower weld head half in figure are numbered with same numbers but with appendix “a” if located in upper half and with appendix “b” if located in lower half.

The design with two independent weld head halves enable the weld head to be moved into and out of contact with the welding position of the work piece located in the work piece receiving zone 16. Each weld head half includes at least one coil winding 12a/12b, which have ends 20a,22a/20b,22b connected to an electrical power source PSa/PSb.

In the figure the coil windings are located in a coil housing 13a and 13b respectively that have a kidney-shaped form corresponding to the same kidney-shaped form of the coil windings 12a and 12b respectively. The coil windings are preferably made with a coil wire of substantial cross section and with as low electrical resistance as possible, and in this case with as few coil turns as 5-10, or as shown in figure with only 6 coil turns. As the induction coil should be activated very quickly and develop high current, the electrical inductance as well as resistance should be kept low. Each coil winding 12a/12b is made by a highly conductive metal such as aluminum or copper, enclosing a coil cavity within the coil housing 13a and 13b. The entire coil housing 13a/13b could be molded or casted in one piece, by a resinous- epoxy- or other polymeric material, forming the kidney-shaped outer contour. The coil cavity and interspaces between coil windings could also be filled with an iron core in either solid or laminated structure (not shown in figures).

The abutting contacting surfaces 14 is preferably provided with an electrically insulating coating applied in any appropriate manner. This coating may also be provided in the contact surface between the work piece and the weld head half.

Such an insulating interface in contact surfaces 14 reduces the opportunity for creating arching and thus erosion/wear of the contact surfaces, as well as mechanical load on coils when sudden arching occurs. An insulating layer is applied to at least one of the contact surfaces.

In FIG. 1 is the work piece receiving zone 16 encircled by shapers in form of semi circular members, i.e. one upper semi circular member 15a in upper weld head half 10a, and another lower semicircular member 15b integrated in the lower weld head half 10b. This is the preferred form if the tubular profile to be welded is a thin walled circular tube. However, these members 15a/15b could have alternative forms being complementary surfaces to the form of the tubular profile to be welded, i.e. may have a triangular shape, a square shape, pentagonal shape, hexagonal shape or other shape than strictly circular. The shaper could as indicated above have a coating of an insulating material, or may alternatively be made in its entirety by an insulating material.

The shaper is integrated with a connecting member 17a/17b that permanently connects the shaper with the associated weld head housing. The upper weld head half 10a thus consist of the kidney-shaped coil housing 13a, the connecting member 17a and the shaper 15a. The power source PSa is preferably connected to the upper weld head connections 22a and 20a via any suitable flexible electrical conductors. The connecting member 17a/17b may preferably be made in a low resistance conductive material such as copper, aluminum or steel.

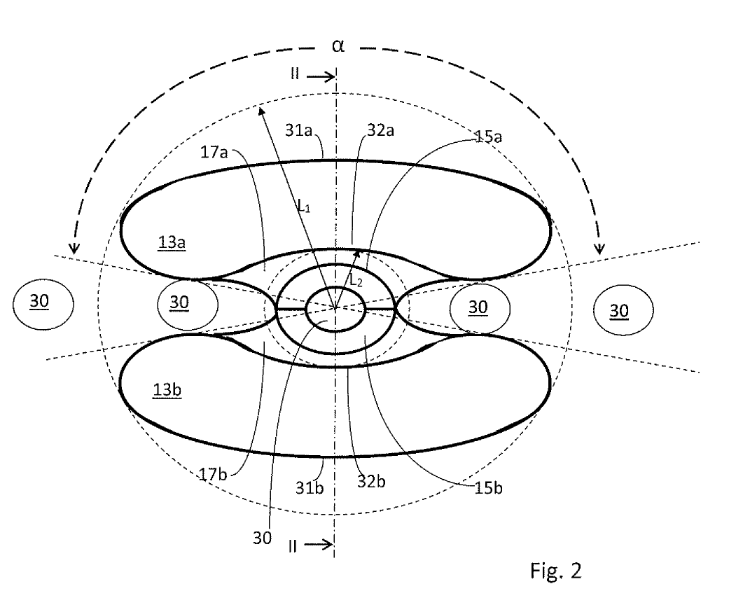

In FIG. 2 is shown the principle layout of the weld head design as seen in a flat view. The induction coils are integrated in the kidney-shaped coil housing 13a and 13b respectively. The coil housing thus has one concave surface 32a facing a concave coil surface 32b of the other half, and a convex coil surface 31a or 31b facing in the opposite direction. Each weld head half has a shaper 15a, 15b located in the housing and in the center of the concave coil surface, wherein the shaper has semi-circular opening corresponding to the outer surface of the tubular profile 30 to be welded. In FIG. 2 are 5 tubular profiles 30 shown located in the same plane.

When welding head halves are brought together for welding, as shown in FIG. 2, the kidney-shaped coil housing 13a and 13b is lying within a circular sector having its center at the center of the tubular profile 30, with a central angle a less than 160° of said circular sector. The central angle a could preferably lie in the range 130-160° of said circular sector, and as could be realized from figure are lower order of angle in this range preferred if the tubular profiles are located closer together in the product to be assembled.

The kidney-shaped coil housing 13a and 13b is further located between an outer arc length L₁ and an inner arc length L₂ of said circular sector, said outer arc length being located radially outside of and adjacent to the convex coil surfaces 31a, 31b and the inner arc length being located radially inside of and adjacent to the concave coil surfaces 32a,32b.

By this design could access be made possible to both closed tubular structures as well as tubular profiles located closely together.

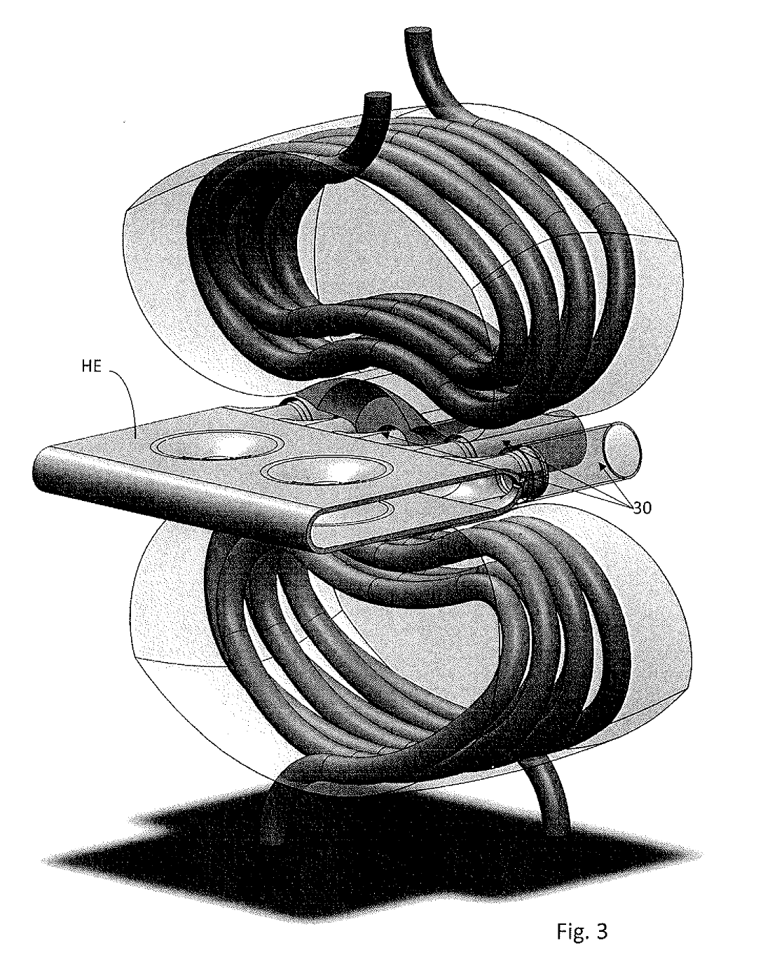

In FIG. 3 is disclosed a work piece in form of tubular heat exchangers. Such heat exchangers typically has one header HE at one end and with a multitude of tubular pipes 30 connected to the header HE, and another header (not shown) in the other end of the tubular pipes 30, thus forming a closed tubular structure.

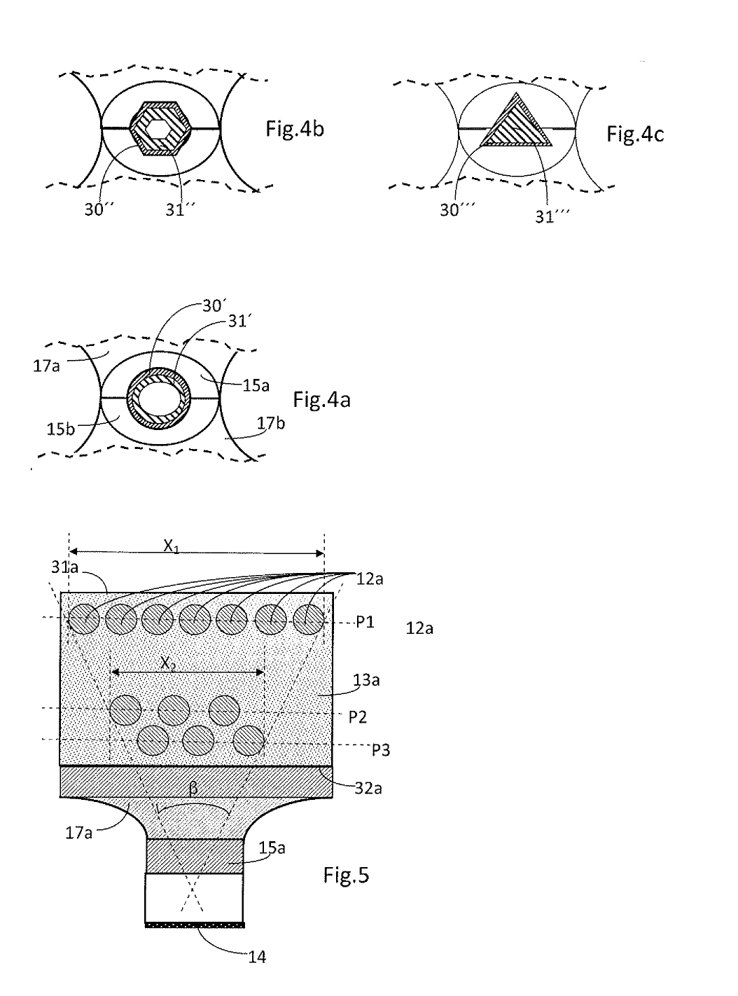

In FIGS. 4a-4c are shown different forms of work pieces to be welded by the welding head. First, in FIG. 4a is shown a work piece in form of an outer thin-walled tubular or cylindrical member 30′ which to be welded together with an inner member 31′ having a complementary outer form, i.e. also with a cylindrical outer form. This inner member 31′ may as shown here be tubular as well, or may also alternatively be a solid rod. Each shaper half 15a and 15b has thus a semi-circular form corresponding to half of the circumferential distance of the hollow thin-walled profile 30″.

Alternatively, as shown in FIG. 4b, the work piece has an outer thin-walled hexagonal member 30″ which to be welded together with an inner member 31″ having a complementary outer form, i.e. also with a hexagonal outer form. Each shaper half 15a and 15b has thus a form corresponding to half of the surface of the hollow thin-walled profile 30″.

In yet another embodiment, as shown in FIG. 4c, the work piece has an outer thin-walled triangular member 30′″ which to be welded together with an inner member 31′″ having a complementary outer form, i.e. also with a triangular outer form. In this embodiment the inner member is solid. Each shaper half 15a and 15b has thus a form corresponding to half of the circumferential distance of the hollow thin-walled profile 30′″.

In FIG. 5 is shown a cross sectional view seen in II-II in FIG. 2 of upper weld head half 10a. The housing 13 has the coil winding 12a encapsulated in any suitable resin material in solid state fashion. The connecting member 17a is an integral part of the housing and connects the hosing with the shaper 15, and an insulating material is suitably applied on the contact surface 14 as indicated in figure. In this embodiment is the part of the coil winding lying closest to the convex surface 31a wound in one single plane P1, while the part of the coil winding lying closest to the concave surface 32a wound in two planes P2 and P3, such that coil windings are partly overlapping. Thus, as shown in FIG. 5 is a welding head obtained, wherein each induction coil winding 12a has a first part of the coil winding, lying furthest away from the shaper 15a and located closest to the convex coil surface 31a, which is wound such that entire part of the coil winding width extends over a distance X₁ and preferably that this part of the coil winding lies in one and the same plane P1. Each induction coil winding 12a has also a second part of the coil winding lying closest to the shaper 15a/and located closest to the concave coil surface 32a which is wound such that entire part of the coil winding width extends over a distance X₂, wherein the distance X₂ is less than 80% of the distance X₁ and preferably that this second part of the coil winding lies in at least two planes P2,P3 such that coil winding turns are partly overlapping in this second part of the coil winding. By this design of the coil winding is the electromagnetic pulse directed towards the center of the shaper 15a, with coil winding wound within an angle β as shown in FIG. 5.

However, the type of coil winding and if a solid or laminated iron core is used is a matter of optimization of the electromagnetic field as directed towards the shaper, and may thus be modified in a number of ways.

It is to be understood that the above description and the related figures are only intended to illustrate the present solution. Thus, the solution is not restricted only to the embodiment described above and defined in the claims, but many different variations and modifications, which are possible within the scope of the idea defined in the attached claims, will be obvious to a person skilled in the art.

1. A welding head for magnetic pulse welding of hollow thin-walled profiles to an inner member having a complementary outer form to said hollow thin-walled profiles, said welding head comprising:
two movable weld head halves forming said welding head wherein each of said weld head halves includes at least one individual induction coil connected to a power source independently from the other weld head half;
and where said at least one individual induction coil in each weld head half is wound in a kidney-shape having a concave coil surface facing in a first direction towards a corresponding concave coil surface of the other of said weld head halves, and a convex coil surface facing in a direction opposite to said first direction, and at least two coil housings wherein each of said induction coils is integrated in one of said at least two coil housings;
each of said weld head halves including a shaper attached to one of said at least two housings at the center of the concave coil surface, wherein the shaper has an opening corresponding to half of the outer surface of the hollow thin-walled profile to be welded, and when the weld head halves are moved together around the hollow thin-walled profile to be welded the shapers totally enclose the hollow thin-walled profile at the location for the weld.

2. A welding head as claimed in claim 1, wherein at least one of the shapers includes an electrically insulating material at least in the contact surface between the shapers.

3. A welding head as claimed in claim 2, wherein the shapers includes an electrically insulating material between said shaper and the outer surface of the hollow thin-walled profile.

4. A welding head as claimed in claim 1, wherein each induction coil winding, when the two moveable welding halves are brought together for welding, is lying within a circular sector having its center at the center of the hollow thin-walled profile, with a central angle (α) of said circular sector lying in the range of 130-160°, and between an outer arc length (L₁) and an inner arc length (L₂) of said circular sector, said outer arc length being located radially outside of and adjacent to the convex coil surface and the inner arc length being located radially inside of and adjacent to the concave coil surface.

5. A welding head as claimed in claim 4, wherein the central angle (α) is less than 140° of said circular sector.

6. A welding head as claimed in claim 4, wherein each induction coil winding has a first part of the coil winding lying furthest away from the shaper and located closest to the convex coil surface being wound such that the entire part of the coil winding width extends over a distance X₁ and preferably that this part of the coil winding lies in one and the same plane (P1), and wherein each induction coil winding has a second part of the coil winding lying closest to the shaper and located closest to the concave coil surface being wound such that entire part of the coil winding width extends over a distance X₂, wherein the distance X₂ is less than 80% of the distance X₁.

7. A welding head as claimed in claim 6, wherein each induction coil winding has less than ten coil turns.

8. A welding head as claimed in claim 7, wherein each induction coil winding has a coil thread with a cross section area exceeding 0.5 cm².

9. A welding head as claimed in claim 6, wherein the second part of the coil winding lies in at least two planes such that coil winding turns are partly overlapping in the second part of the coil winding.
